(19) United States
(12) Patent Application Publication
(10) Pub. No.: US 2008/0079235 A1
(43) Pub. Date: Apr. 3, 2008

(54) Tubular cushioning device for bicycle

(76) Inventors: Kuo Chih Chao, Taichung (TW); Chia Pin Chen, Taichung (TW)

Correspondence Address: CHARLES E. BAXLEY, ESQ., 90 JOHN STREET, THIRD FLOOR, NEW YORK, NY, 10038, US

(21) Appl. No.: 11/729,244

(22) Filed: Mar. 27, 2007

(30) Foreign Application Priority Data
Oct. 2, 2006 (TW) 095136614

(51) Int. Cl. B62K 21/22

(52) U.S. Cl. 280/279; 403/359.6

(57) ABSTRACT

A tubular cushioning device for a bicycle includes a tubular and longitudinal member having a hollow bore and two or more grooves for allowing the tubular and longitudinal member to be temporarily bent or deformed and for allowing the tubular and longitudinal member to cushion and absorb a force that may be transmitted to the tubular and longitudinal member and to the bicycle riders and for allowing the bicycle riders to comfortably ride the bicycle. The grooves may be formed in the upper side, the lateral sides or the bottom side, and the tubular and longitudinal member includes a post binding cylinder for engaging with a handle post, and a bar binding collar for engaging with a handlebar.

### BACKGROUND OF THE INVENTION

1. Field of the Invention

The present invention relates to a tubular cushioning device, and more particularly to a tubular and longitudinal supporting and cushioning device including a cushioning structure for attaching to a bicycle and for cushioning or absorbing the forces that may be transmitted to the bicycle riders and for allowing the bicycle riders to comfortably ride the bicycle.

2. Description of the Prior Art

Typical bicycles comprise a bicycle frame formed by a number of tubular and longitudinal supporting members secured together by such as welding processes, and one or more spring members, shock absorbing members, pneumatic or hydraulic cylinders, or other spring cushioning members are further provided and attached or coupled to the bicycle frame for cushioning or absorbing the forces that may be transmitted to the bicycle riders and for allowing the bicycle riders to comfortably ride the bicycle.

The typical bicycles further comprise a handle or handlebar attached or disposed on top of a front tube or a handle post for supporting the upper portion of the users. However, the handle or handlebar is normally attached or disposed on top of the front tube or the handle post directly or indirectly via a stem extension tube without any spring members, shock absorbing members, pneumatic or hydraulic cylinders, or other spring cushioning members such that the forces applied to the bicycle may be directly transmitted to the upper portion of the bicycle riders and the bicycle riders may feel uncomfortable after riding the bicycle.

For example, U.S. Pat. No. 4,783,187 to McMurtrey discloses one of the typical bicycle handlebar stem assemblies and also comprising a bicycle handle or handlebar attached or disposed on top of a front tube or a handle post or a steering post with a bottom plate and a top plate for supporting the upper portion of the users.

However, the bicycle handle or handlebar is directly attached or disposed on top of the front tube or the handle post with the bottom plate and the top plate without any spring members, shock absorbing members, pneumatic or hydraulic cylinders, or other spring cushioning members such that the forces applied to the bicycle may also be directly transmitted to the upper portion of the bicycle riders and the bicycle riders may also feel uncomfortable after riding the bicycle.

U.S. Pat. No. 4,939,950 to Girvin discloses another typical bicycle handlebar stem assembly and comprises a bicycle handle or handlebar attached or disposed on top of a front tube or a handle post or a column member with a pivot arm for supporting the upper portion of the users.

However, the bicycle handle or handlebar is directly attached or disposed on top of the front tube or the handle post with the pivot arm without any spring members, shock absorbing members, pneumatic or hydraulic cylinders, or other spring cushioning members such that the forces applied to the bicycle may also be directly transmitted to the upper portion or the hands of the bicycle riders and the bicycle riders may also feel uncomfortable after riding the bicycle.

U.S. Pat. No. 5,144,859 to Malone discloses a further typical bicycle handlebar stem assembly and comprises a bicycle handle or handlebar directly attached or disposed on top of a front tube or a handle post or a column member for supporting the upper portion of the users.

However, the bicycle handle or handlebar is also directly attached or disposed on top of the front tube or the handle post without any spring members, shock absorbing members, pneumatic or hydraulic cylinders, or other spring cushioning members such that the forces applied to the bicycle may also be directly transmitted to the upper portion or the hands of the bicycle riders and the bicycle riders may also feel uncomfortable after riding the bicycle.

U.S. Pat. No. 5,197,350 to Borromeo discloses a still further typical bicycle handlebar stem assembly and comprises a bicycle handle or handlebar attached or disposed on top of a front tube or a handle post or a column member with a pivot stem for supporting the upper portion of the users.

However, the bicycle handle or handlebar is also directly attached or disposed on top of the front tube or the handle post with the pivot stem without any spring members, shock absorbing members, pneumatic or hydraulic cylinders, or other spring cushioning members such that the forces applied to the bicycle may also be directly transmitted to the upper portion of the bicycle riders and the bicycle riders may also feel uncomfortable after riding the bicycle.

U.S. Pat. No. 5,251,494 to Edwards discloses a still further typical bicycle handlebar stem assembly and comprises a bicycle handle or handlebar attached or disposed on top of a front tube or a handle post or a column member with a pivot stem for supporting the upper portion of the users.

However, the bicycle handle or handlebar is also directly attached or disposed on top of the front tube or the handle post with the pivot stem without any spring members, shock absorbing members, pneumatic or hydraulic cylinders, or other spring cushioning members such that the forces applied to the bicycle may also be directly transmitted to the upper portion of the bicycle riders and the bicycle riders may also feel uncomfortable after riding the bicycle.

The present invention has arisen to mitigate and/or obviate the afore-described disadvantages of the conventional bicycle handlebar stem supporting devices.

### SUMMARY OF THE INVENTION

The primary objective of the present invention is to provide a tubular and longitudinal supporting and cushioning member including a cushioning structure for attaching to a bicycle and for cushioning or absorbing the forces that may be transmitted to the bicycle riders and for allowing the bicycle riders to comfortably ride the bicycle.

In accordance with one aspect of the invention, there is provided a tubular cushioning device for a bicycle comprising a tubular and longitudinal member including a hollow bore formed therein, and including a first groove and at least one second groove formed in the tubular and longitudinal member for allowing the tubular and longitudinal member to be temporarily bent or deformed and for allowing the tubular and longitudinal member to cushion and absorb a force that may be transmitted to the tubular and longitudinal member and to the bicycle riders and for allowing the bicycle riders to comfortably ride the bicycle.

The tubular and longitudinal member includes an upper side having either of the first groove or the second groove formed therein, and/or includes a lateral side having either of the first groove or the second groove formed therein, and/or includes a bottom side having either of the first groove or the second groove formed therein.

The tubular and longitudinal member includes a wider portion and a narrower portion formed in either of the first groove or the second groove of the tubular and longitudinal member.

The tubular and longitudinal member includes a rear end having a post binding cylinder provided therein for engaging with a handle post. The post binding cylinder is preferably perpendicular to the tubular and longitudinal member.

The tubular and longitudinal member includes a front end having a bar binding collar provided therein for engaging with a handlebar. The bar binding collar includes a front cap and a rear cap for clamping and securing the handlebar between the front cap and the rear cap. The bar binding collar is preferably perpendicular to the tubular and longitudinal member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a tubular cushioning device in accordance with the present invention for attaching to a bicycle and having a cushioning structure for cushioning or absorbing the forces that may be transmitted to the bicycle riders;

FIG. 2 is an enlarged perspective view of the tubular cushioning device for the bicycle;

FIG. 3 is an enlarged perspective view similar to FIG. 2, illustrating the other arrangement of the tubular cushioning device for the bicycle;

FIGS. 4, 5, 6, 7, 8 are enlarged perspective views similar to FIGS. 2 and 3, illustrating the further arrangement of the tubular cushioning device for the bicycle;

FIG. 9 is a perspective view illustrating the still further application of the tubular cushioning device for the bicycle; and

FIG. 10 is a perspective view similar to FIG. 9, illustrating the still further arrangement of the tubular cushioning device for the bicycle.

### DETAILED DESCRIPTION OF THE PREFERRED EMBODIMENT

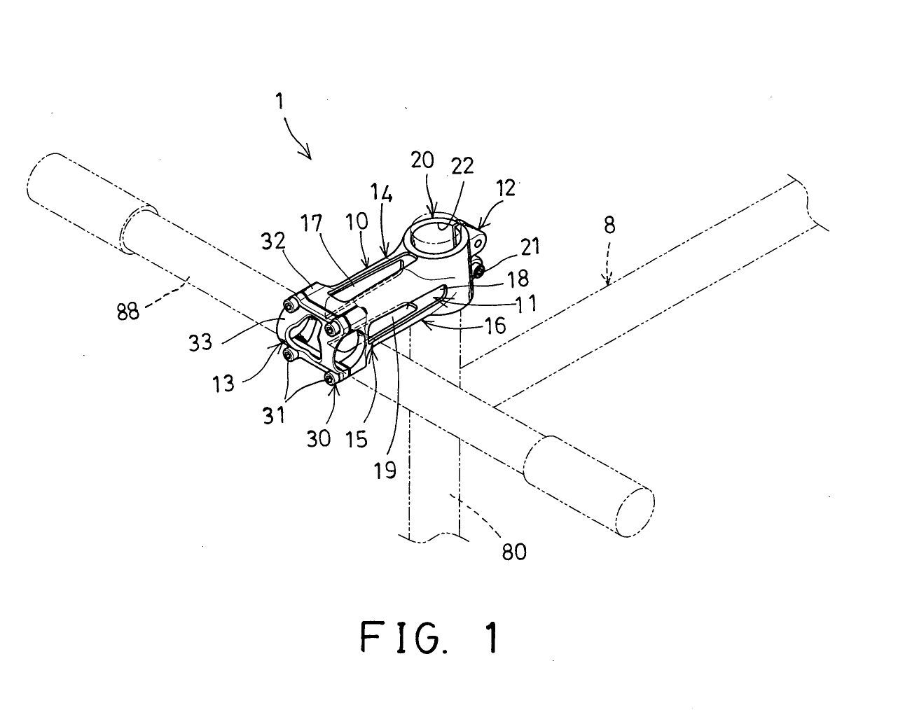

Referring to the drawings, and initially to FIGS. 1 and 2, a tubular cushioning device 1 in accordance with the present invention comprises a tubular and longitudinal member 10 including a hollow bore 11 formed therein, and including a rear end 12 for attaching to a front tube or steering tube or handle post 80 of a bicycle 8, and including a front end 13 for attaching or supporting a handle or handlebar 88. The tubular and longitudinal member 10 includes four sides, such as an upper side 14, two lateral sides 15, and a bottom side 16, and includes a circular or polyhedron structure or includes a polygonal structure, and preferably, but not necessarily includes a rectangular or square or other polygonal cross section.

The tubular and longitudinal member 10 further includes a post binding cylinder 20 formed or provided or attached to the rear end 12 of the tubular and longitudinal member 10, for engaging onto the handle post 80 and for securing to the handle post 80 with such as fasteners 21 and thus for allowing the tubular and longitudinal member 10 and the handle post 80 to be rotated in concert with each other and for steering purposes. The post binding cylinder 20 is arranged perpendicular to the tubular and longitudinal member 10, and includes a chamber 22 formed therein for receiving the handle post 80, and the chamber 22 of the post binding cylinder 20 is preferably, but not necessarily communicating with the bore 11 of the tubular and longitudinal member 10.

The tubular and longitudinal member 10 further includes a bar binding collar 30 formed or provided or attached to the front end 13 of the tubular and longitudinal member 10, for engaging with the handlebar 88 and for securing to the handlebar 88 with such as fasteners 31 and thus for allowing the tubular and longitudinal member 10 and the handlebar 88 to be rotated in concert with each other and also for steering purposes. The bar binding collar 30 is also arranged perpendicular to the tubular and longitudinal member 10, and further arranged perpendicular to the post binding cylinder 20, and includes a front cap 32 and a rear cap 33 for clamping the handlebar 88, and for allowing the handlebar 88 to be clamped and secured between the front cap 32 and the rear cap 33 of the bar binding collar 30 with such as the fasteners 31. The above-described structure or the post binding cylinder 20 and the bar binding collar 30 are not related to the present invention and will not be described in further details.

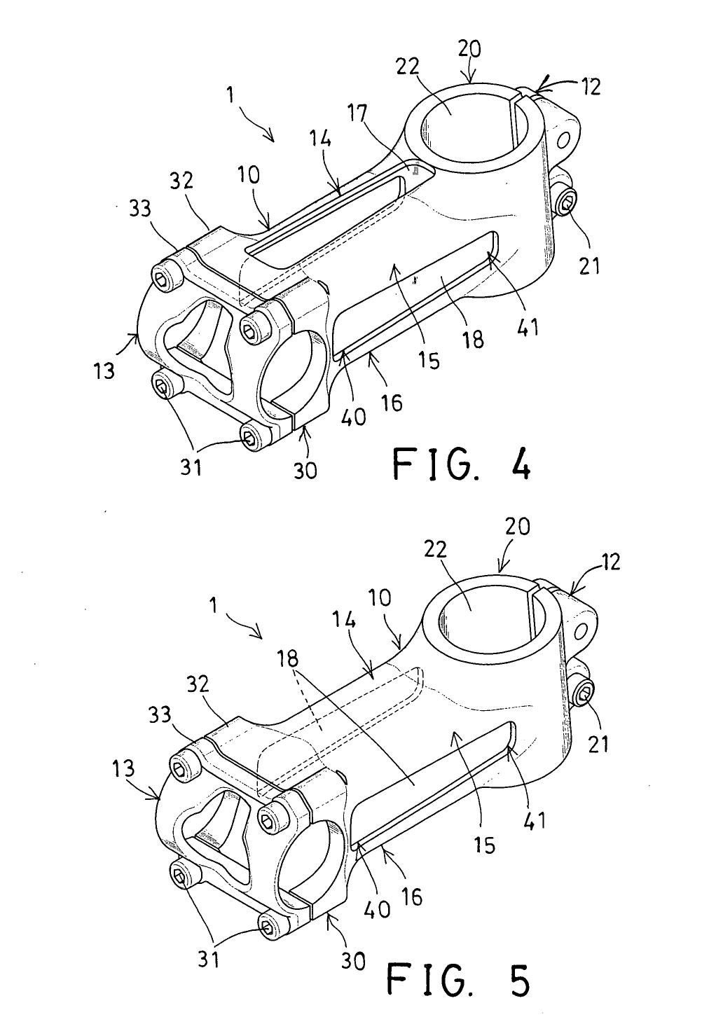

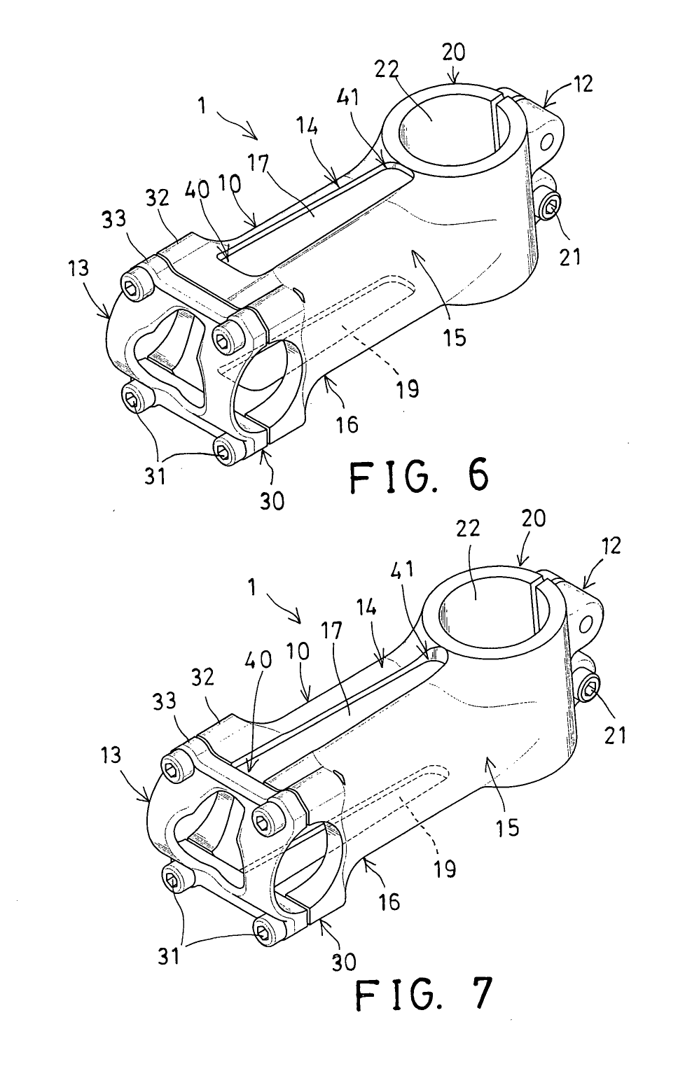

The tubular cushioning device 1 in accordance with the present invention further includes one or more cutoff portions or channels or grooves 17, 18, 19 formed therein, such as one or more longitudinal grooves 17 formed in the upper side 14 of the tubular and longitudinal member 10 (FIGS. 1-4, 6-8), and one or more longitudinal grooves 18 formed in each of the lateral sides 15 of the tubular and longitudinal member 10 (FIGS. 1-5, 8), and one or more longitudinal grooves 19 formed in the bottom side 16 of the tubular and longitudinal member 10 (FIGS. 1-3, 6-7), and the grooves 17, 18, 19 are preferably, but not necessarily formed and extended from the post binding cylinder 20 toward the bar binding collar 30 or extended between the post binding cylinder 20 and the bar binding collar 30.

The formation and the provision of the grooves 17, 18, 19 in the tubular and longitudinal member 10 and between the post binding cylinder 20 and the bar binding collar 30 may suitably increase the resilience of the tubular and longitudinal member 10 and allows the tubular and longitudinal member 10 to be suitably or temporarily, but not permanently bent or deformed, and thus for allowing the tubular and longitudinal member 10 to suitably cushion or absorb the forces that may be transmitted to the tubular and longitudinal member 10 and the handlebar 88 and then to the bicycle riders and for allowing the bicycle riders to comfortably ride the bicycle 8. The grooves 17, 18, 19 of the tubular and longitudinal member 10 may include various shapes or contours.

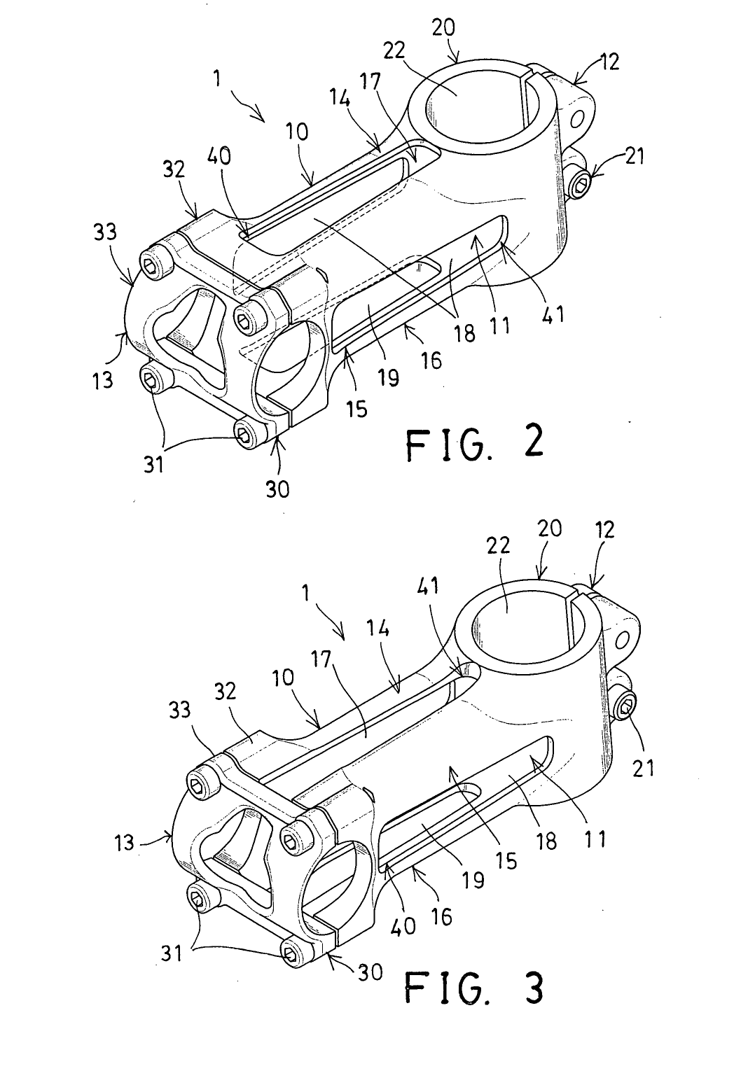

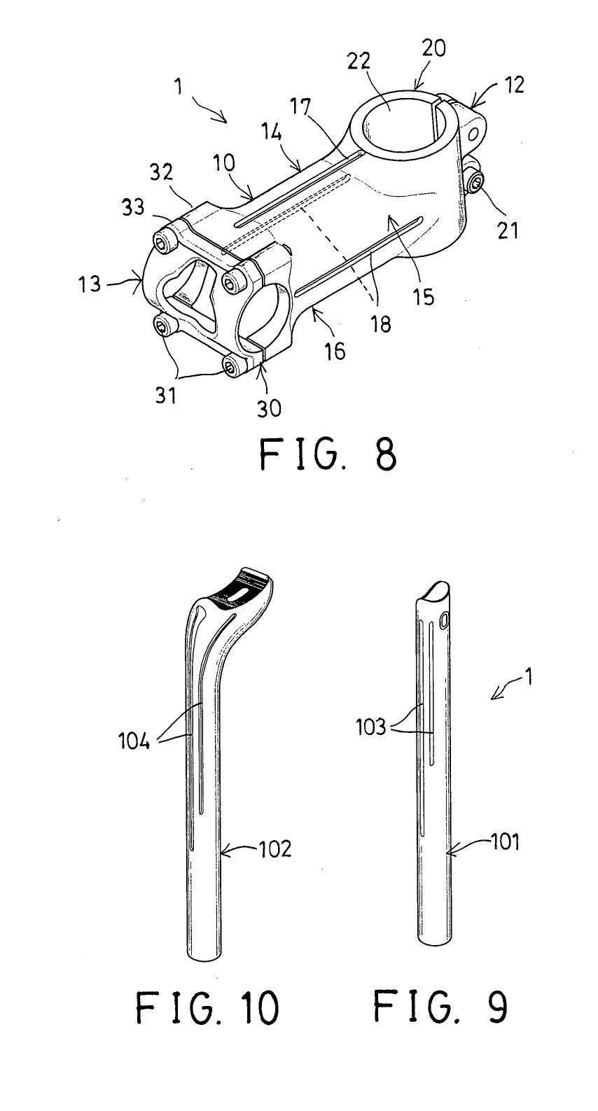

For example, the tubular and longitudinal member 10 may include such as a wider front portion 40 and a narrower rear portion 41 (FIGS. 1-7) for each of the grooves 17, 18, 19 of the tubular and longitudinal member 10, or the grooves 17, 18, 19 of the tubular and longitudinal member 10 may include the same width throughout the length thereof (FIG. 8), and/or may include the rectangular (FIGS. 1-2, 4-6) or rounded (FIGS. 3, 7) end portions. The shapes or contours of the grooves 17, 18, 19 of the tubular and longitudinal member 10 as shown in FIGS. 3-8 are provided for illustrating purposes.

Alternatively, as shown in FIGS. 9-10, the tubular and longitudinal member 101, 102 of the tubular cushioning device 1 in accordance with the present invention may be disposed vertically and formed or acted as a seat post, and may also include one or more cutoff portions or channels or grooves 103 (FIG. 9), 104 (FIG. 10) formed therein, such as one or more longitudinal grooves 103, 104 formed in the peripheral portion of the tubular and longitudinal member 101, 102 for allowing the tubular and longitudinal member 101, 102 to be suitably or temporarily, but not permanently bent or deformed, and thus for allowing the tubular and longitudinal member 101, 102 to suitably cushion or absorb the forces that may be transmitted to the tubular and longitudinal member 101, 102 and the bicycle seat (not shown) and then to the bicycle riders and for allowing the bicycle riders to comfortably ride the bicycle 8.

Accordingly, the tubular and longitudinal supporting and cushioning member in accordance with the present invention includes a cushioning structure for attaching to a bicycle and for cushioning or absorbing the forces that may be transmitted to the bicycle riders and for allowing the bicycle riders to comfortably ride the bicycle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tubular cushioning device for a bicycle comprising:
a tubular and longitudinal member including a hollow bore formed therein, and including a first groove and at least one second groove formed in said tubular and longitudinal member for allowing said tubular and longitudinal member to be temporarily bent or deformed and for allowing said tubular and longitudinal member to cushion and absorb a force that may be transmitted to said tubular and longitudinal member.

2. The tubular cushioning device as claimed in claim 1, wherein said tubular and longitudinal member includes an upper side having either of said first groove or said at least one second groove formed therein.

3. The tubular cushioning device as claimed in claim 1, wherein said tubular and longitudinal member includes a lateral side having either of said first groove or said at least one second groove formed therein.

4. The tubular cushioning device as claimed in claim 1, wherein said tubular and longitudinal member includes a bottom side having either of said first groove or said at least one second groove formed therein.

5. The tubular cushioning device as claimed in claim 1, wherein said tubular and longitudinal member includes a wider portion and a narrower portion formed in either of said first groove or said at least one second groove of said tubular and longitudinal member.

6. The tubular cushioning device as claimed in claim 1, wherein said tubular and longitudinal member includes a rear end having a post binding cylinder provided therein for engaging with a handle post.

7. The tubular cushioning device as claimed in claim 6, wherein said post binding cylinder is perpendicular to said tubular and longitudinal member.

8. The tubular cushioning device as claimed in claim 1, wherein said tubular and longitudinal member includes a front end having a bar binding collar provided therein for engaging with a handlebar.

9. The tubular cushioning device as claimed in claim 8, wherein said bar binding collar includes a front cap and a rear cap for clamping and securing the handlebar between said front cap and said rear cap.

10. The tubular cushioning device as claimed in claim 8, wherein said bar binding collar is perpendicular to said tubular and longitudinal member.
